(19) United States
(12) Patent Application Publication
(10) Pub. No.: US 2009/0306892 A1
(43) Pub. Date: Dec. 10, 2009

(54) OPTICAL DISTANCE VIEWING DEVICE HAVING POSITIONING AND/OR MAP DISPLAY FACILITIES

(75) Inventors: Isaac Malka, Rehovot (IL); Israel Rom, Reut (IL)

Correspondence Address: MARTIN D. MOYNIHAN d/b/a PRTSI, INC., P.O. BOX 16446, ARLINGTON, VA, 22215, US

(73) Assignee: ITL OPTRONICS LTD., Petach-Tikva (IL)

(21) Appl. No.: 12/224,944

(22) PCT Filed: Sep. 20, 2006
(86) PCT No.: PCT/IL2006/001103

§ 371 Date: Feb. 5, 2009

(30) Foreign Application Priority Data
Mar. 20, 2006 (IL) 174412

(51) Int. Cl. G01C 21/00

(52) U.S. Cl. 701/213

(57) ABSTRACT

An optical distance viewing device has position and/or map display facilities that can be shown simultaneously with the optical view. The device includes a remote view acquisition module for acquiring a remote view; a location module for acquiring a location; a map module for generating a map in accordance with the acquired location; and an output module for outputting an image which shows the optical view together with the map, or current location co-ordinates or both. An enhancement projects the view onto a 3D map.

### FIELD AND BACKGROUND OF THE INVENTION

The present invention relates to a method and imaging tool for positioning or map display for an optical distance viewing device.

The rapid miniaturization of complex electronic circuits and the emergence of high-resolution displayers have vastly increased the number and variety of smart devices with displays. Such devices include hand-held computers, mobile telephones, pagers and other communication and computing solutions. Moreover, processing power, data storage capability, communication speed, and battery life of portable devices continue to develop at an accelerated pace. These developments have influence, inter alia, on conventional navigation and autonomous devices such as binoculars or Global Positioning System (GPS) units which have, consequently, advanced during the last decade.

New navigation and autonomous devices integrate several complex electronic circuits such as positioning modules that provide additional information about the position of both the device itself and other chosen objects. The new navigation and autonomous devices are designed as compact hand-held systems that can aid infantry soldiers, military vehicles, and other forces to orient and navigate better. Such devices may comprise laser range finders, digital compasses, inclinometers, etc. Such integration of positioning modules enables the output of a variety of positional information. This information includes the device's position relative to Earth and the device's position relative to visible objects.

In order to maximize the use of such devices, different methods have been developed to exhibit the positional information to the users.

U.S. Pat. No. 6,181,302, issued on Jan. 30, 2001, discloses a system including navigation binoculars with a virtual display superimposing the real world image. The patent discloses a binocular-augmented device with a computer-generated virtual display of navigation information. The computer-generated display is superimposed on the real world image, available to the user. The system also has components to link the device to a navigation system computer which is utilized to generate the see-through display of the navigation information. The device is equipped with a compass and an inclinometer for acquiring azimuth and inclination information needed by the navigation computer and a sensor for measuring any magnification of the field of view. The device can be employed to lock onto a moving target, which can then be tracked by onboard radar. The navigation device also accepts inputs from other sources such as a compass, a GPS, a navigation aid system, and a route planning system. Once the alignment of the virtual display of navigation information and the actual field of view is completed, the virtual overlay is transmitted in coded form to a video output component of the navigation computer and forwarded to the system where the virtual display is constructed and superimposed on the real world view.

As described above, the system enables the user to simultaneously view a portion of the surroundings and a virtual display of navigation information. However, since the display is superimposed on a real world image, the user cannot look at the region in which he is located from another point of view. Moreover, this device is adjusted for marine vehicles and has to be connected to external sources in order to receive some of the positional information. Though the connection can be a wireless connection, the device has to be positioned at a limited reception distance from the external sources in order to enable the establishment and the maintenance of the connection. Such a non-autonomous device cannot be used by infantry soldiers or by basic vehicles that do not have a digital compass, a GPS unit, and other navigational aids that can generate the requested positional information. Moreover, such a device cannot perform target acquisition functions.

Other navigation devices integrate imaging sensors for night vision. Night vision sensors, such as infrared (IR) sensors, are used to enable visual navigation and target recognition at night and in dark areas.

Known orientation and navigation devices also integrate positional information databases which can be used to display area maps that may assist the navigation device operators to navigate in certain areas. For example, U.S. Pat. No. 6,401,032, issued on Jun. 4, 2002, discloses apparatus for automatically disseminating information corresponding to a location of the user. The apparatus comprises a location identification device for providing a current location, a presentation device for presenting the information to a user, a controller to control the presentation device, and a storage device to store the information and predefined location data linking the location to the information.

Though the patent discloses an apparatus that automatically disseminates information corresponding to a location of the user, the disclosed apparatus cannot be used for identifying specific objects or to estimate their location. The apparatus is limited to predetermined knowledge and does not allow the operator to acquire environmental and spatial orientation regarding his actual location.

There is thus a widely recognized need for, and it would be highly advantageous to have, a device for navigation, orientation and target acquisition devoid of the above limitations.

### SUMMARY OF THE INVENTION

According to one aspect of the present invention there is provided an apparatus for enhanced remote viewing that comprises a remote view acquisition module for acquiring a remote view, a location module for acquiring a location, a map module for generating a map in accordance with the location, and an output module for outputting an image comprising at least one of the remote view, the map and a combination thereof.

Preferably the map module comprises a map repository configured to store a plurality of maps, each map comprising reference information, and a computing unit for matching the reference information of the plurality of maps with the location, the computing unit being configured generating the map based on the matching.

More preferably the apparatus further comprises a data connection, wherein the map repository is adapted to access the plurality of maps via the data connection.

More preferably the apparatus the data connection comprise at least one of the following connections: an RS-232 connection, an Ethernet connection, an Universal Serial Bus (USB) connection, a Firewire connection, an USB2 connection, a Bluetooth® connection, an IR connection, a CompactFlash™ card drive, a SmartMedia™ card drive, a Memory Stick™ card drive, a Secure Digital™ card drive, a miniSD™ card drive, and a MicroSD™ card drive.

More preferably the apparatus the location module comprises a Global Positioning system (GPS) module, wherein the location comprises at least one of the following information: the latitude of the apparatus, the longitude of the apparatus, time reference data, and the elevation of the apparatus.

More preferably the apparatus further comprises the location module comprises a range finding module configured to output range information regarding a chosen object.

More preferably the apparatus further comprises a range finding module is a laser range finding module, configured to determine at least one of a direction to and a velocity of a viewed object.

Preferably, the map module uses the location and the range information to calculate target positional information, wherein the view comprises a representation of the target positional information.

More preferably the apparatus further comprises a communication interface. The communication interface is used to transmit the target positional information.

More preferably, the apparatus further comprises a pointer module, configured to point to the chosen object. Preferably, the pointer module comprises at least one of the following group: a low power Infrared (IR) laser diode, and aluminum gallium arsenide (AlGaAs) laser diode.

Preferably, the output module is an ocular viewer.

Preferably, the remote view acquisition module comprises at least one of the following sensors: complementary metal oxide semiconductor (CMOS) sensor, Charge Coupled Device (CCD) sensor, I² (Image Intensifier) sensor and a thermoelectric sensor.

More preferably, the remote view acquisition module comprises a set of positionable optical lenses that image the remote view so as to form a field of view of a real image of the remote view.

More preferably, the remote view comprises an eyepiece lens assembly is positioned to cover the ocular viewer.

More preferably, the location module comprises a compass module adapted to output horizontal angular information regarding the apparatus.

More preferably, the output module is adapted to display the horizontal angular information.

Preferably, the apparatus further comprises a transmission unit configured to transmit the viewing signals of the image comprising at least one of the remote views.

Preferably, the apparatus further comprises a communication interface configured to transmit the viewing signals of the image comprising at least one of the remote view, and of the map.

Preferably, the apparatus the communication interface is configured to receive operational instructions. The operational instructions are used to control the functionalities of the apparatus. Preferably, the communication interface is configured to receive an external visual image from an associated device, wherein the ocular viewer is used to display the external visual image.

Preferably, the apparatus the image comprising the combination and wherein the combination is a split view that simultaneously display a first visual image based on the map and a second visual image based on the remote view.

Preferably, the apparatus further comprises a cellular transmitter, wherein the cellular transmitter is used to send the virtual image using Multimedia Messaging Service (MMS) protocol.

According to another aspect of the present invention there is provided a method for using an apparatus for generating a real world image and a map area display relating thereto, comprising the steps of: a) generating a first image from the surrounding environment, b) receiving positional information in relation thereto, c) generating a second image comprising a map defined according to the positional information, and d) displaying either the first image or the second image or a combination thereof according to a user selection.

Preferably, the method further comprising a step between aforementioned steps b) and c) of selecting an object, and a step measuring the distance between the device to the object. The second image depicts the distance. Preferably, the method further comprising a step between b) and c) of matching the positional information with a plurality of area maps stored on the device to identify an area map that depicts the positioning of the device.

More preferably, the plurality of area maps is stored on a replaceable memory device which is connected to the device.

According to another aspect of the present invention there is provided an autonomous multifunctional device for generating a virtual image for orientating, navigating and target acquiring. The autonomous multifunctional device comprising: a daylight sensor for outputting an image of daylight from a portion of the surrounding environment, a nightlight sensor for outputting a nighttime image from a portion of the surrounding environment, a range finding module for outputting the distance between the autonomous multifunctional device and a remotely located object, a compass for outputting the horizontal angular positioning of the autonomous multifunctional device, and an ocular viewer for generating a virtual image according to the outputs.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and apparatus of the present invention involves performing or completing certain selected tasks or steps manually, automatically, or a combination thereof. Moreover, according to actual instrumentation and equipment of preferred embodiments of the method and apparatus of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and apparatus of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of an exemplary remote viewing device for outputting orientation and navigation information based upon positional information and image sensors, according to a preferred embodiment of the present invention;

FIG. 2 is a perspective view of an exemplary remote viewing device, according to a preferred embodiment of the present invention;

FIGS. 3A, 3B, 3C, and 3D are a set of exemplary illustrations of a screen display of area maps, according to various embodiments of the present invention;

FIG. 4 is a schematic representation of a rear perspective view of an exemplary remote viewing device for facilitating navigation, orientation and target acquisition, according to a preferred embodiment of the present invention;

FIG. 5 is a view of a remote viewing device positioned on a tripod and remotely controlled by an operator, according to a preferred embodiment of the present invention;

FIG. 6 is an exemplary visual image which has been generated by the remote viewing device, according to a preferred embodiment of the present invention;

FIG. 7 is a simplified flowchart diagram of a method for using a remote viewing device for generating a daylight image and a map area display, according to a preferred embodiment of the present invention; and

FIG. 8 is a simplified flowchart diagram of the method of FIG. 7 further comprising a step of comparing the positional information which has been previously received with a number of area maps, according to a preferred embodiment of the present invention.

### DESCRIPTION OF THE PREFERRED EMBODIMENTS

The present embodiments comprise an apparatus and a method for autonomously generating a real world image and a map of a related region for orientation, navigation, and target acquisition.

One embodiment of the present invention depicts an apparatus for acquiring remote view, and more particularly for orientation, navigation and target acquisition. The apparatus is preferably an autonomous remote viewing device that comprises several components. One component is an observation unit for imaging light reflected from a portion of the surrounding environment so as to form a field of view of an image of the portion of the surrounding environment. Different sensors may be used, for either daylight or thermoelectric radiation, depending on the type of radiation that is to be sensed by the device. The observation unit is configured to generate image viewing signals of the field of view. The autonomous device further comprises a location module for generating information relative to the position of the device. The positional information is used as input for a map module which is configured to generate map viewing signals of an area map according to the positional information. The area map reflects the device's position and facilitates navigation and orientation for the device operator. The device further comprises an ocular viewer which is used for generating a virtual image of the generated map and the generated image. In a preferred embodiment of the present invention, the location module further comprises a range finding module that allows the device operator to estimate the distance between the device and objects in the field of view and to acquire targets.

Another embodiment of the present invention is a method for using an autonomous device for generating a daylight image and a map area display which is related to the nearby area. The first step of the method is generating a first image of light reflected from a portion of the surrounding environment. The second step is receiving positional information from a positioning module of the device regarding the current position of the device. The next step is generating a second image of an area map according to the positional information. The final step is displaying either the first image or the second image.

The principles and operation of the device and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

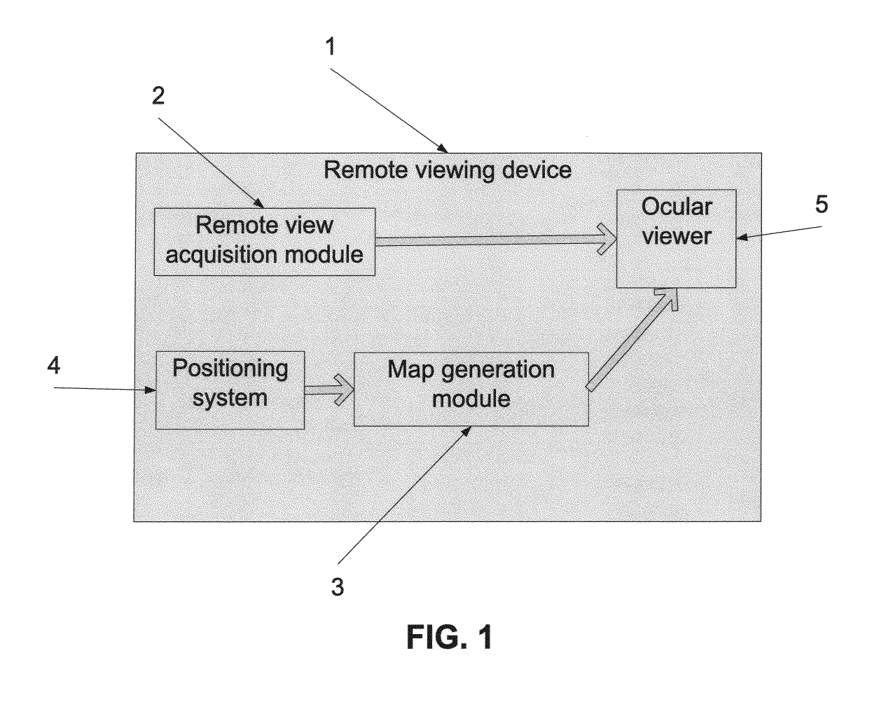

Reference is now made to FIG. 1 which depicts an exemplary remote viewing device 1 for outputting orientation and navigation information based upon positional information and image sensors. Remote viewing device 1 comprises a remote view acquisition module 2 and a map module 3. The map module 3 is connected to an ocular viewer 5 and to a location module 4.

The remote viewing device is, preferably, a compact, lightweight system, ideal for infantry units engaged in day and night, naval and ground operations.

The remote view acquisition module 2 is used for imaging light reflected from a portion of the surrounding environment so as to form a field of view of a real image of the portion of the surrounding environment. Preferably the remote view acquisition module 2 generates image viewing signals that represent the aforementioned imaging light. The map module 3 is used for generating map viewing signals that represent an area map which has been chosen according to positional information outputs of the location module 4.

As depicted in FIG. 1, both the map module 3 and the remote view acquisition module 2 are connected to the ocular viewer 5. The ocular viewer 5 receives the map viewing signals and the image viewing signals via these connections. The ocular viewer 5 is used for displaying the visual image according to the viewing signals of either the map module 3 or the remote view acquisition module 2, as chosen by the device operator, as described below.

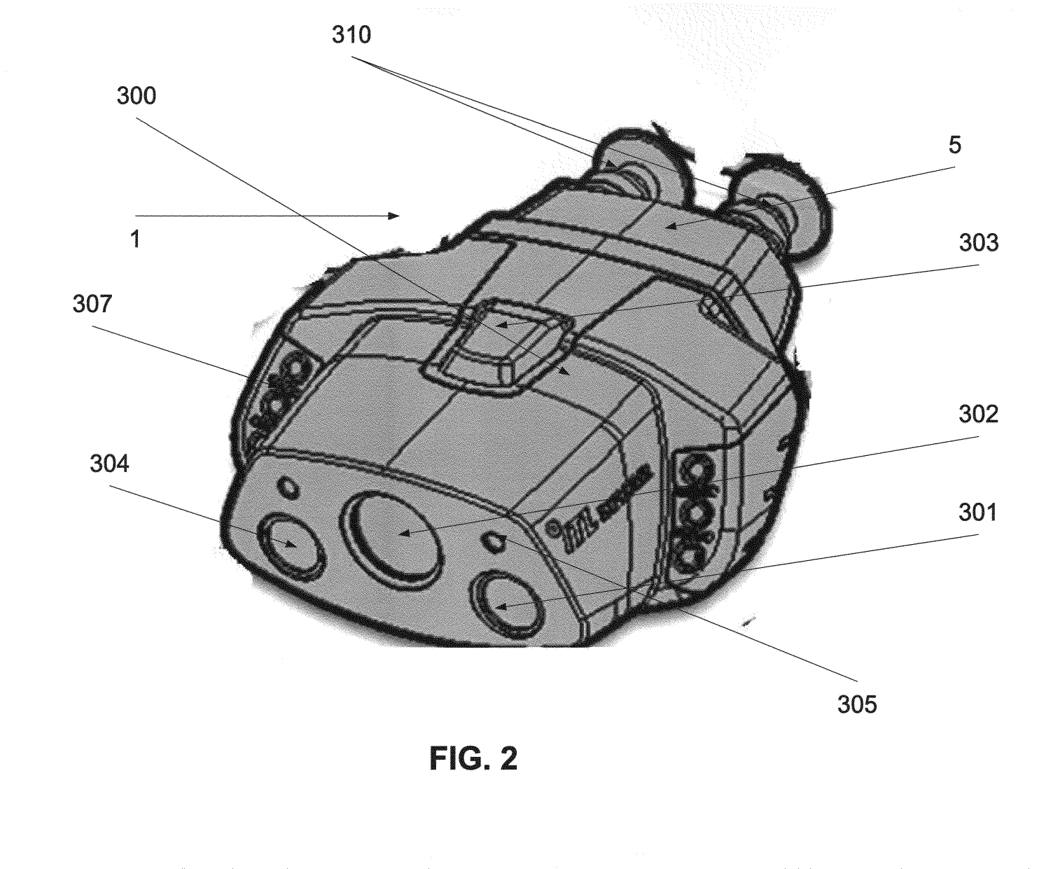

Additional reference is now made to FIG. 2 which depicts a perspective view of the remote viewing device 1 represented in FIG. 1. FIG. 2 depicts a durable housing 300 that encompasses the components of the remote viewing device 1. Preferably, all exterior surfaces of the housing 300 and all the exterior screw heads and other external components have a matte, dark coating or a painted finish.

In a preferred embodiment of the present invention, the remote view acquisition module 2 (FIG. 1) comprises a daylight image sensor. As shown at 301, the daylight image sensor is mounted at the front of the observation module 1. The daylight image sensor 301 is used to capture a daylight picture of a portion of the surrounding environment. A complementary metal oxide semiconductor (CMOS) based image sensor or a charge coupled device (CCD) based image sensor can be used as a daylight image sensor 301. As is commonly known, both CCD and CMOS image sensors comprise arrays of thousands or millions of tiny solar cells, each of which transforms the light from one small portion of the image into electrons. The electrons digitally represent a 2-D image of the light reflected from a portion of the surrounding environment. After the light has been transformed, the sensors generate an output that comprises a digital representation of the aforementioned 2-D image. Both CCD and CMOS devices perform this task using a variety of technologies which are generally well known in the art and are, therefore, not described here in greater detail.

In a preferred embodiment of the present invention, the observation unit of the remote viewing device 1 further comprises a nightlight image sensor such as a thermoelectric radiation detector 302 or I² sensor, mounted at the front of the observation module 1. Preferably, the thermoelectric radiation detector 302 is an infrared (IR) image detector. The IR image detector is a sensing device that detects radiation in the infrared band having wavelengths from 750 nm to 1 mm. The detected radiation is transformed into a 2-D image of the infrared radiation reflected from a related portion of the surrounding environment. Preferably, the IR image detector is cooled, so as to increase its sensitivity. The cooling is achieved by thermoelectric (TE) cooling, by the use of an immersion lens, or both. Usually, TE-cooled detectors have to be mounted on a heat sink and have to be connected to a power supply. The IR detector generates an output that comprises a digital representation of the aforementioned 2-D image. Since the thermoelectric radiation detector is used to detect a flow of heat, it can be used to generate an image of a portion of the surrounding environment both during nighttime and daytime.

The IR detector and the cooled IR detector perform this task using a variety of technologies which are generally well known in the art and are, therefore, not described here in greater detail.

Preferably, the daylight image sensor 301 and the thermoelectric radiation detector 302 each comprises a set of positionable optical lenses that image radiation reflected from a portion of the surrounding environment so as to form a field of view of a real image of the portion of the surrounding environment. Each set of positionable optical lenses comprises objective lenses that can be maneuvered to change the field of view from a distant view to a more close-up view and vice versa. In a preferred embodiment of the present invention, the image sensors comprise a digital zoom module which is used to crop a portion of the image and then to enlarge it to the size of the original image. Digital zoom is generally well known in the art and is, therefore, not described here in greater detail.

As depicted in FIG. 2, a set of zoom buttons 307 is positioned on the left side of the housing 300 of the remote viewing device 1. The set of zoom buttons 307 is used by the operator of the device to change the field of view of the daylight and the nightlight sensors, as described below.

The digital output of the image of each of the daylight and nightlight image sensors is transferred to an ocular viewer 5 that displays the received image. Preferably, the ocular viewer 5 comprises a liquid-crystal display (LCD) screen or a color organic light-emitting diode (OLED) screen. The viewing area is configured such that it corresponds approximately to the size of an eye, preferably, 12.78 mm×9 mm.

In a preferred embodiment of the present invention the remote viewing device 1 is used as a camera. As described above, the remote viewing device 1 may be used in military operations to provide needed intelligence. In order to allow analyzing of the image which has been captured by either the daylight image sensor 301 or the nightlight image sensor 302, the remote view acquisition module 2 may function as a camera. In a preferred embodiment, the digital output of the image of each of the daylight and nightlight image sensors may be stored in a file. Preferably, the remote view acquisition module 2 further comprises a designated memory which can be used to store the captured images. In another embodiment, the remote viewing device further comprises a communication interface module that facilitates the transmission of the captured images to a designated destination. For example, a cellular transmitter may be used to send the image file to an email address or as a picture message to a designated cellphone. Other transmitters, such as radio transmitters, may used to transmit the image files. For example, Wi-Fi or other standards for wireless local area networks (WLAN) based on the IEEE 802.11 specification transmitters may be used to transmit the image file.

As depicted in FIG. 2, the remote viewing device 1 comprises an assembly having a pair of eyepieces 310 positioned to cover the ocular viewer 5. Preferably, each eyepiece 310 comprises a lens having a focal length between 24 mm and 27 mm, and a transmittance level between 85% and 100%. In use, the eyepieces are positioned in between the ocular viewer 5 and the user's eyes. Preferably, each eyepiece comprises a collimator for collimating radiation. The collimator is preferably shaped as a long narrow tube in which strongly absorbing or reflecting walls permit only radiation traveling parallel to the tube axis to traverse its entire length. Preferably the collimator is elbow shaped.

Preferably, the lens of each eyepiece 310 is coated with an anti-reflective coating material to minimize the reflection of light having a wavelength in between the UV and IR ranges.

Reference is now made, once again, to FIG. 1. As described above, the map module 3 is connected to a location module 4. The location module 4 is used for generating positional information relative to the remote viewing device 1. In a preferred embodiment of the present invention, the location module 4 comprises a GPS module. The GPS module is configured to generate the latitude and the longitude coordinates of the remote viewing device 1, time reference data, and a measure of the elevation of the remote viewing device 1. Preferably, the GPS module is a Lassen® iQ GPS OEM board produced by Trimble™. The GPS module is connected to a GPS antenna 303, which is mounted on the upper side of the remote viewing device 1. Preferably the GPS module is further connected to an antenna interface which is configured to be connected to an external GPS antenna using a designated cable.

In a preferred embodiment of the present invention, the location module 4 comprises a compass module. The compass module is adapted to generate signals that indicate the orientation of the remote viewing device 1 relative to the Earth's magnetic poles. Preferably, a floating core fluxgate magnetometer (FCFM) is used as a compass. Because the Earth's magnetic field has a vertical component which varies, depending on location in the world, the FCFM device is used to indicate the orientation of the remote viewing device 1 relative only to the part of the magnetic field which has influence on a core which is positioned inside the FCFM, when it is held in the horizontal plane.

In particular, the FCFM is an electromagnetic device that employs two or more small coils of wire wound around a core of non-linear magnetic material, to directly sense the direction of the horizontal component of the Earth's magnetic field. The FCFM outputs digital signals that indicate the orientation of the remote viewing device 1 relative to the Earth's magnetic poles.

In order to improve accuracy, the compass module may have to be calibrated. It should be mentioned that the compass module, like any other magnetometer, measures magnetic flux. Therefore, magnetic interferences affect the performance of the compass module. Hence, in order to improve the reliability of the compass module, a calibration should be carried out while the remote viewing device 1 is positioned away from any metal objects such as vehicles, concrete walls with metal infrastructure, and radiating objects such as communication equipment.

In a preferred embodiment of the present invention, the location module 4 comprises a range-finding module 304, mounted at the front of the device 1. The range-finding module 304 is used to indicate the range between the remote viewing device 1 and a remotely located object which is positioned in sight. Preferably, the range-finding module 304 is a laser range finding (LRF) module. The LRF module, which is also known as a light detection and ranging (LIDAR) module, comprises an electronic board assembly, a transmitter assembly, and a receiver assembly.

The electronic board assembly comprises a computing unit and a power supply unit. The dimensions of the electronic board assembly are preferably less than 60 mm wide, 90 mm long and 25 mm high.

The transmitter assembly is preferably a laser diode, such as a pumped solid-state glass diode, which is used to emit light, preferably projected by a lens (which may be an integral part of the laser diode package) onto a remotely located object. Preferably, the diode produces a passive Q-switched laser beam having a center wavelength of 1540±5 nm. The laser diode receives its power supply from the power supply unit.

The receiver assembly is preferably a photodiode that is configured to receive the light which has been emitted from the transmitter assembly and is reflected from the remotely located object. Preferably, the photodiode is an avalanche photodiode (APD) that comprises alloys of indium arsenide (InAs), gallium arsenide (GaAs), indium phosphate (InP), and gallium phosphate (GaP). The photodiode receives its power supply from the power supply unit.

Preferably, the LRF module further comprises an opto-mechanical assembly (OMA) that provides easy optical coupling between a receiver assembly and the transmitter assembly via optical waveguides.

In use, the transmitter assembly emits a laser pulse in a narrow beam towards a chosen object and the receiver assembly receives the beam which is reflected from the chosen object. In order to determine the distance to the chosen object, a laser pulse in a narrow beam is sent by the transmitter assembly towards the object and the computing unit of the range-finding module is used to measure how long it takes for the pulse to bounce off the target and return to the receiver assembly. The range estimation is output by the LRF module to indicate the distance to the object. Preferably, Doppler Effect techniques are used to determine the velocity and the direction of movement of the chosen object relative to the remote viewing device 1.

In order to enable an operator to choose an object, the location module 4 comprises a pointer module 305. Preferably, the pointer module is a low power laser diode that emits a laser beam in the near IR spectrum that is visible with light, the aforementioned nightlight image sensor 302 having a wavelength between 800 nm and 1550 nm. Such a pointer module enables the device operator to mark an object with an IR colored dot on any surface at which the device is aimed. The advantage of such a mark is that it is below the visible spectrum and cannot, therefore, be seen without a special IR device.

In another embodiment of the present invention the pointer module 305 is a laser emitting diode, such as an aluminum gallium arsenide (AlGaAs) diode that emits a bright red laser beam having a wavelength between 532 nm and 700 nm. The laser beam appears as a colored dot on any surface at which it is aimed.

In both embodiments the light travels in a relatively straight line unless it is reflected or refracted. The laser emitting diode 305 is positioned to emit a beam which is parallel to the beam which is emitted from the range finding module 304. In use, the operator of the remote viewing device 1 aims the colored dot to illuminate the chosen object. Then, the operator utilizes the range finding module 304 to measure the distance between the remote viewing device 1 and the chosen object by emitting a laser beam and calculating the time period is takes for the beam to return from the chosen object. The positioning of the pointer module 305, as described above, ensures that the measured range is correlated with the illuminated object.

Reference is now made, once again, to FIG. 1. In a preferred embodiment of the present invention, the location module 4 comprises an inclinometer. The inclinometer is used to determine the angle of the Earth's magnetic field relative to the horizontal plane of the remote viewing device 1. Preferably, the inclinometer is a solid state accelerometer. The inclinometer outputs digital signals that indicate the tilt angle of the remote viewing device 1 relative to the Earth's magnetic field.

As described above, the remote viewing device 1 comprises a map module 3. Accurate detection of the position of targets and other objects during a military operation may have a significant effect on the outcome of the operation. Crucial information about the current location of the military force that participates in a military operation may have an effect on the functioning of the force during the operation. Accurate positioning of the force relative to targets and to the area enables the force to easily navigate the battlefield and to acquire targets. However, in order to maximize the utility of this information, a display that exhibits a comprehensive point of view of the battlefield that includes the positioning of the force and the targets is needed. A comprehensive point of view of the battlefield allows the force to have better environmental and spatial orientation and increases the situational awareness of the force. Such improvements increase the degree of accuracy of the force's perception of its current environment. One known method to provide a comprehensive point of view of the battlefield is to use maps of the battlefield region. Maps may be used to indicate the positioning of the force and of targets in a manner that enables the force to weigh several factors before beginning operational activities. The map module 3 is used to generate a visual display of the position of the remote viewing device 1 and of chosen targets on the battlefield. The visual display displays a representation, preferably on a planar surface, of the region in which the force is situated.

As described above, the map module 3 is connected to the location module 4 and receives outputs therefrom. The outputs comprise positional information which is used by the map module 3 to identify the current position of the remote viewing device 1. In one embodiment of the present invention, the current position of the remote viewing device 1 is received from the aforementioned GPS module that outputs, inter alia, the latitude, the longitude and the measure of elevation of remote viewing device 1.

The map module 3 further comprises a map repository, which stores numerous area maps, each area map depicting a certain terrain. In addition, each area map comprises reference information which includes the coordinates of the depicted terrain. Preferably, the reference information comprises directional data that represent the azimuth offset between the magnetic north and grid north of the map.

The map module 3 generates virtual images of area maps and transmits the images to the output module, which is, preferably, an ocular viewer 5.

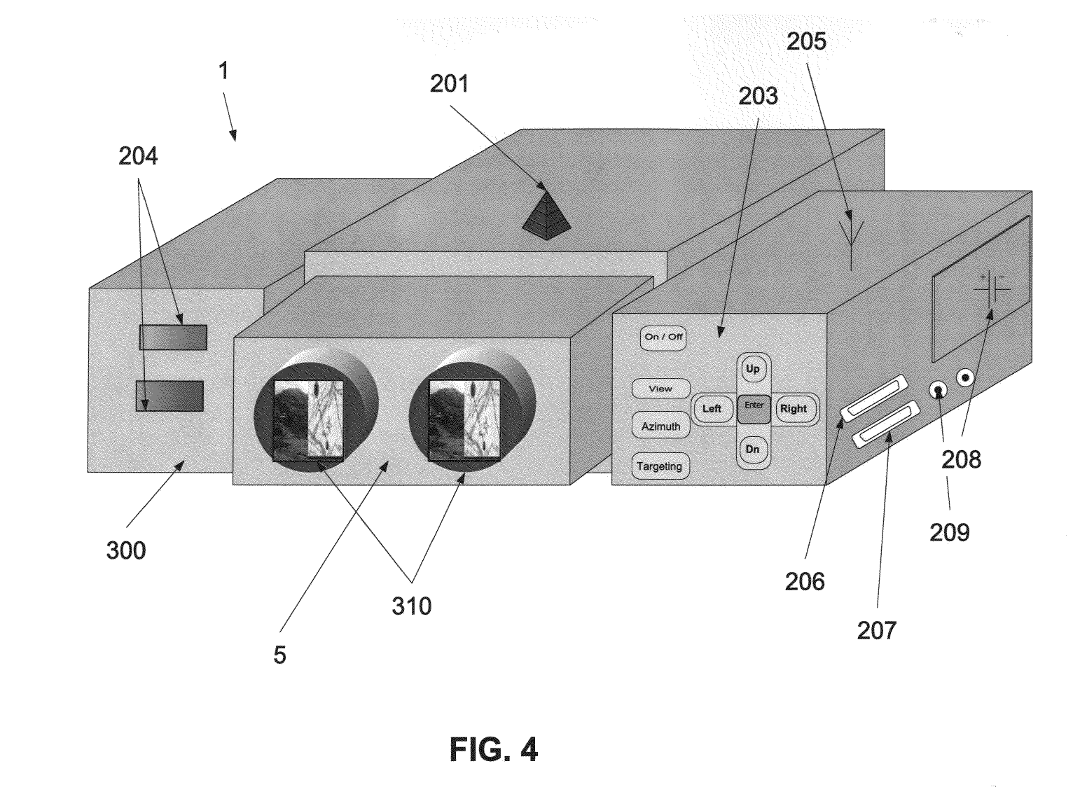

As described above, the ocular viewer 5 is also used to display the outputs of the remote view acquisition module 2. Hence, in order to enable the device operator to view both the outputs of the remote view acquisition module 2 and of the map module 3 the remote viewing device 1 comprises a keypad (FIG. 4) that controls the display of the ocular viewer 5, as described below.

Preferably, the ocular viewer 5 generates a split display. The split display exhibits both the area map, that depicts the terrain surrounding the remote viewing device, and the digital representation of the 2-D image of the light reflected from a portion of the surrounding environment, as described above.

In use, the map module 3 uses a computing unit for comparing the current position of the remote viewing device 1 and the force that operates it with the reference information of each area map in order to determine a match. The area map is marked as depicting the terrain in which the remote viewing device 1 is positioned. After a match has been achieved, the computing unit generates viewing signals that represent the area map that depicts the terrain in which the remote viewing device 1 is located. The viewing signals are transferred to the ocular viewer 5 for generating a virtual image according to the viewing signals.

Based on the area map, the map module 3 outputs a visual image of the terrain in which the remote viewing device 1 is positioned. The visual image may be a three-dimensional (3D) representation, two-dimensional (2D) representation or a geodesic map of the related terrain. The position of the remote viewing device and the remote target are respectively depicted in the same manner.

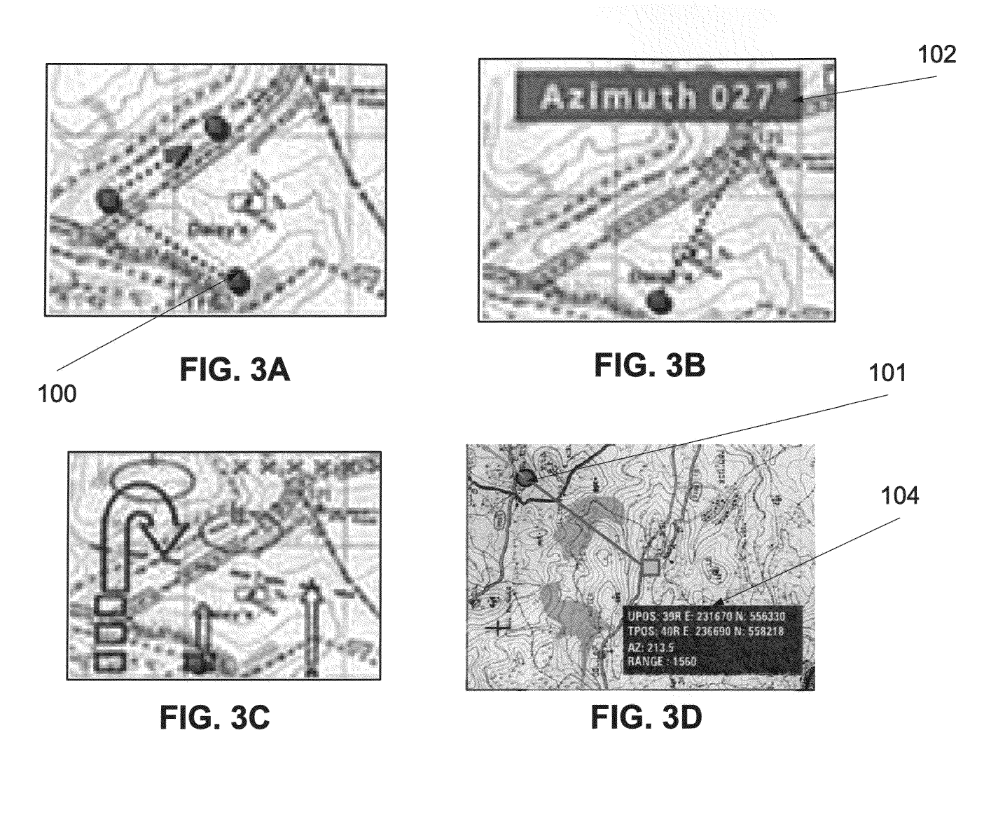

Reference is now made to FIGS. 3A, 3B, 3C, and 3D which are a set of exemplary illustrations of a screen display of area maps which depict the terrain in which the remote viewing device 1 may be located, according to various embodiments of the present invention.

As described above, a display that exhibits a comprehensive point of view of the battlefield depicts the positioning of the force that operates the remote viewing device and the targets. The map module receives positional information from the location module. The positional information indicates the current position of the remote viewing device 1 and the current position of a chosen target. As described above, in a preferred embodiment of the present invention the current position of the remote viewing device is detected by the GPS module of the location module. The current position of the remote viewing device is depicted on the displayed area map that exhibits the terrain in which the remote viewing device is located. Preferably, as depicted in FIG. 3A, the current position of the remote viewing device is indicated by a dot 100 on the displayed area map.

In a preferred embodiment, as described above, the location module outputs information regarding the position of a chosen target. As described above, the GPS module outputs information about the latitude, the longitude and the measure of elevation of the remote viewing device. The range finding module outputs information about the distance between the remote viewing device and the target. The compass outputs information about the horizontal angular position of the remote viewing device. Therefore, the coordinates of the chosen target can be easily calculated. The calculation of the distance to the target can be done using functions which are based on the Pythagorean Theorem.

Preferably, as depicted in FIG. 3D, the current position of the chosen target is symbolized on the displayed area map, as shown at 101, using a different icon than the one which is used to symbolize the remote viewing device. In a preferred embodiment of the present invention, the remote viewing device 1 provides a positional information output. The positional information output enables the system operator to transmit information about the position of a certain acquired target. Preferably, the coordinates of the chosen target 101 are output as the coordinates of the acquired target. This allows the operator to validate the target acquisition process by sensibly matching the 2-D image of the ocular viewer 5 with the chosen target 101 which is displayed on the ocular viewer 5.

Preferably, as depicted in FIG. 3C, operational information about the routes which have to be taken and maneuvers which have to be performed by the force during an operation are also depicted in the visual image which is displayed on the ocular viewer 5.

In another embodiment of the present invention, other positional information is displayed using the ocular viewer 5. As depicted above, the location module may output information about the angular position of the remote viewing device 1. The angular position cannot be depicted on the area map since the area map displays a 2-D image of the related terrain. Hence, as depicted in FIG. 3B the angular position of the remote viewing device 1 may be textually exhibited. Additional positional information, such as the elevation of the remote viewing device 1 or the target coordinates, as depicted in numeral 104 of FIG. 3D, may also be exhibited in a textual manner.

In another embodiment of the present invention, the area maps, which are stored in the map repository, are correlated with a target bank. The target bank comprises various target records; each record comprises positional and descriptive information about the target. In use, targets from the target bank which are correlated with the area map that depicts the terrain of the remote viewing device 1 are depicted by the image displayed by the ocular viewer 5.

Reference is now made to FIG. 4 which depicts a schematic representation of a rear perspective view of an exemplary remote viewing device 1 for facilitating navigation, orientation and target acquisition according to a preferred embodiment of the present invention. The ocular viewer 5 is as in FIG. 2 above. However, FIG. 4 further depicts additional control and interface components.

As depicted in FIG. 4, a control keypad 203 is positioned on the external side of the remote viewing device 1. The control keypad 203 is used by the device operator to operate the different functions of the remote viewing device 1. Preferably, the control keypad 203 may be used to control the display of the ocular viewer and to operate the different modules of the location module. In another embodiment, the control keypad 203 is used to control and adjust the different modules of the location module. For example, the control keypad 203 may be used to calibrate the compass module or to adjust the contrast level of the ocular viewer display.

In order to allow communication between the remote viewing device 1 and other systems, the remote viewing device preferably comprises a communication interface. Preferably, the communication interface is a wireless communication interface that comprises a radio frequency (RF) transmitter 205 that communicates with an RF receiver which is integrated into the communicating system. Bluetooth®, a standard for short-range digital transmission, can be used as a communication protocol for the RF communication.

Preferably, device 1 comprises a communication interface 206, which provides wired serial communication. The serial communication may include an RS-232 connection, an Ethernet connection, a universal serial bus (USB) connection, a Firewire connection, a USB2 connection, a Bluetooth® connection or an IR connection. Preferably, the USB or the USB2 connection can be used as a power supply, supplying electrical current to the remote viewing device 1.

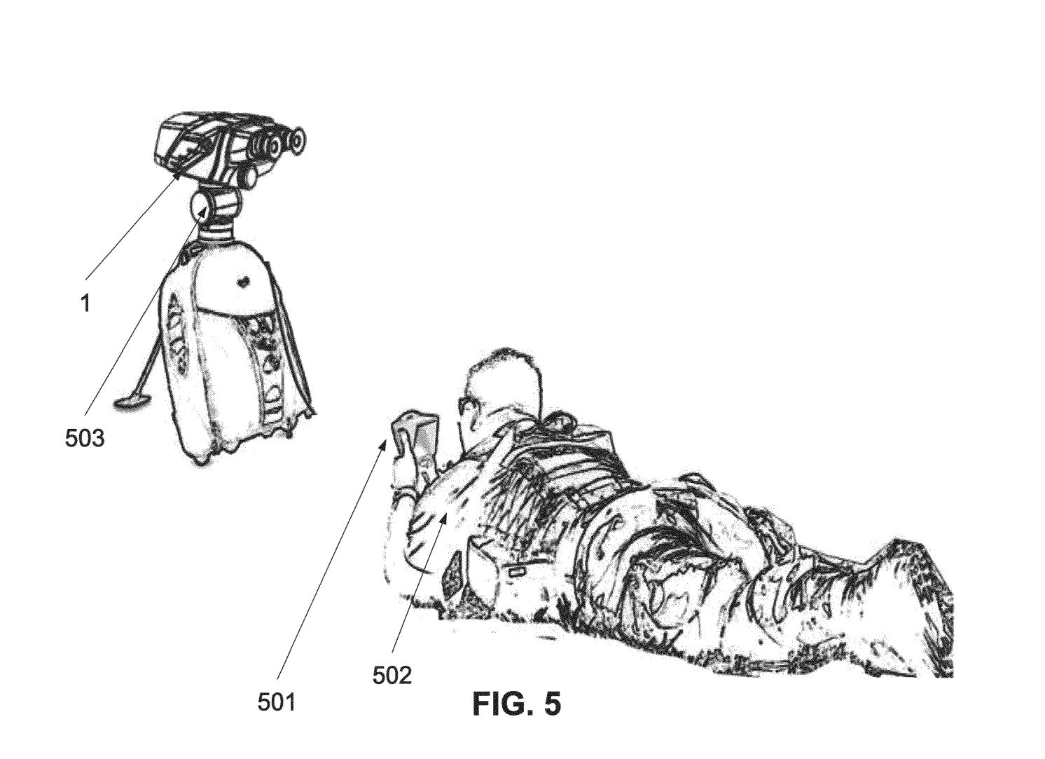

Reference is now made to FIG. 5 which depicts an exemplary remote viewing device 1 positioned on a tripod 503 and controlled by an operator 502 who is remotely located from the remote viewing device 1. As depicted in FIG. 5, the communication interface may be used for establishing communication with a remote control unit 501. Preferably, the remote control unit is a Personal Digital Assistant (PDA) device or a Rugged Tablet PC (RTPC) that runs a designated application. Preferably, the visual display signals, which are sent to the ocular viewer from both the map module and the observation unit, are wirelessly transmitted to the remote control unit 501. In addition, the communication interface is used to allow the remote control unit to control all the aforementioned functions of the remote viewing device 1, enabling operation of the remote viewing device 1 from a remote location. This allows the device operator 502 to stay in a safe position while the remote viewing device 1 is positioned in an exposed location. For example, the remote viewing device 1 may be positioned at a high and unprotected position that provides the device operator a good vantage point of the surrounding area. The communication interface allows the device operator to receive a visual display, which is usually displayed using the ocular viewer, and to operate the remote viewing device 1 from a remotely located shelter.

In another embodiment, the remote viewing device 1 is connected to other orientation and navigation devices. As described above, the remote viewing device 1 can be used to assist military forces during military operations. Usually, more then one force takes part in such a military operation. In addition, in such complex operations the military forces are spread across the battlefield. Hence, each force is placed in a different location and has a different vantage point of the battlefield, targets and objects.

In order to provide a more comprehensive perspective of the battlefield, the communication interface of the remote viewing device 1 facilitates the reception and transmission of visual images. Preferably, the communication interface may be used to transmit the visual display signals which are sent to the ocular viewer to another associated remote viewing device or to another associated device. In addition, the communication interface may be used to receive visual display signals from other associated devices which depict the battlefield from other points of view. In a preferred embodiment of the present invention, a wireless communication network, preferably encoded, is established between a number of associated devices. The wireless communication network may be established according to Wi-Fi or other standards for a WLAN. Preferably, the WLAN is established using a wireless router that enables communication between different associated devices. For example, a wireless router, carried by an armored personnel carrier (APC) or by another military vehicle such as a high-mobility multipurpose wheeled vehicle (HMMWV), may be used to establish a wireless communication network among the remote viewing device 1, other remote viewing devices, and other portable devices which are configured to communicate with the remote viewing device 1. The associated devices which are connected to the WLAN may share visual images of different points of view. Preferably, the wireless communication network is connected to the Internet or to another network, allowing other people, such as the commander of operation, to receive the visual images from the connected devices. In one preferred embodiment of the present invention the keypad, as shown at 203 of FIG. 4, may be used by the system operator to add graphical signs and icons to the transferred visual images. This embodiment enables the system operator to mark a certain target or certain tactical move with the operators of the associated devices.

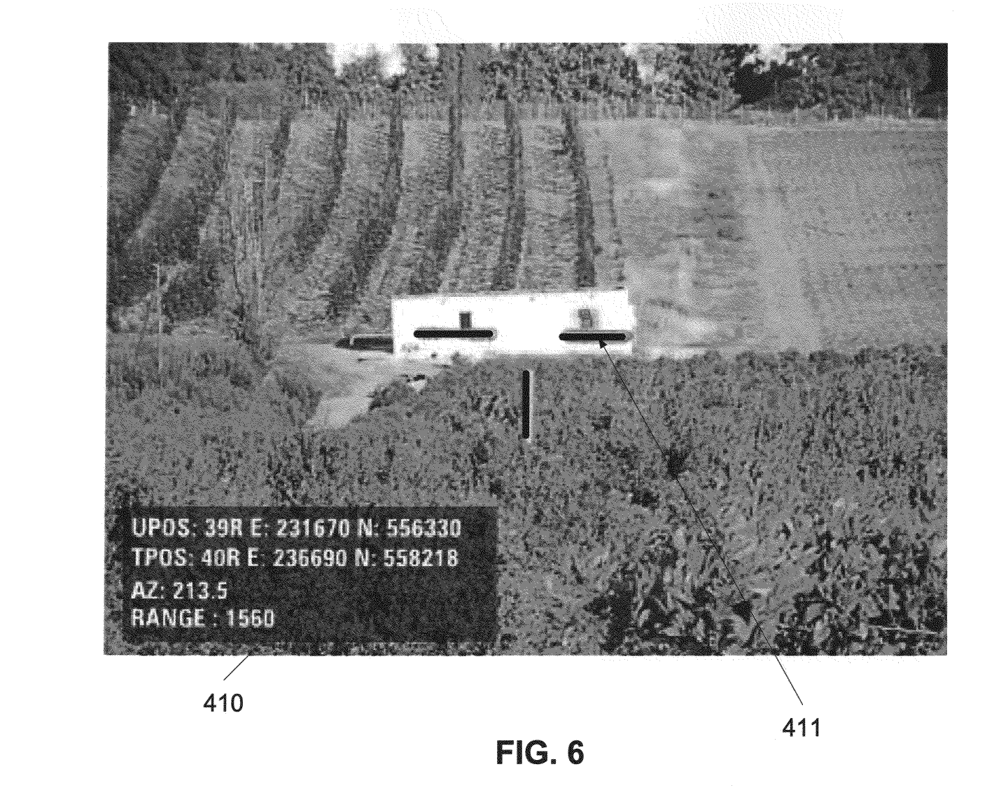

Reference is now made to FIG. 6, which is an exemplary visual image which has been generated by the ocular viewer based upon the daylight image sensor 301 (FIG. 2). As shown in FIG. 6, the ocular viewer preferably generates a cross 411 that represents the center of the field of view which has been captured by the daylight image sensor. Preferably, the ocular viewer generates a similar cross to represent the center of the field of view which has been captured by the nightlight image sensor 302 (FIG. 2). The cross further represents an area in the field of view which is positioned in a direct line of vision of the remote viewing device.

In a preferred embodiment, the remote viewing device is used for target acquisition. As described above, the remote viewing device comprises viewing sensors and range finding modules. These modules can be use to acquire targets and to transmit information about the acquired targets to other systems. In one embodiment the operator uses the ocular viewer to position a target in the center of the visual display, at the cross 411. Then, the device operator presses a designated button on the side of the remote viewing device to actuate the range finding module. The range finding module detects the range to the object which is located at the center of the cross 411. Then, as described above, the coordinates of the object can be easily calculated to determine the exact position of the object. Preferably, the positional information of the object is displayed by the ocular viewer as textual information, as shown at 410. The device operator may press another button to transmit the positional information of the object to another system. The positional information of the chosen object may be used, for example, for targeting the object for an attack.

Reference is now made, once again, to FIG. 4. The use of the remote viewing device 1 is not limited to a certain terrain. The remote viewing device 1 may be used in different areas of the world. Hence, the map module 3 should be able to generate a visual display of a substantial number of area maps. Preferably, the map module 3 is connected to a communication interface that facilitates the updating of the map repository with new maps. Preferably, the communication interface 207 provides wired serial communication. The serial communication may include an RS-232 connection, an Ethernet connection, a universal serial bus (USB) connection, a Firewire connection, a USB2 connection, a Bluetooth® connection or an IR connection. Preferably, a USB based flash memory drive (disk on key) is used to update the map repository with new area maps and the target bank with new targets. Preferably, the communication interface provides wireless communication.

In another embodiment, the map repository is positioned on memory cards which can easily be replaced. The memory cards are preferably solid-state electronic flash memory data storage devices such as CompactFlash™ cards, SmartMedia™ cards, Memory Stick™ cards, Secure Digital™ cards, miniSD™ cards, or MicroSD™ cards.

As mentioned above, the map module 3 comprises a target bank. The target bank may have to be updated in order to account for changes in the position of certain targets and in order to include new, as yet undocumented targets.

The remote viewing device 1 is connected to a power supply. The electrical current to the remote viewing device 1 can be either from an Alternating Current (AC) source or from a Direct Current (DC) source. Preferably, the remote viewing device 1 comprises an AC source connector 209. Preferably, the remote viewing device 1 further comprises a battery housing 208 for supplying DC electric current. The battery housing can house either rechargeable batteries or regular batteries.

Preferably, the remote viewing device 1 comprises a tripod 503 (FIG. 5) having a mechanical adapter, which enables the operator to connect the tripod to the bottom of the housing of the remote viewing device. Preferably, the tripod is provided with a standard ¼″ UNC mounting adapter with a keyway, which can be connected to a 3-point standard NATO Bayonet point adapter.

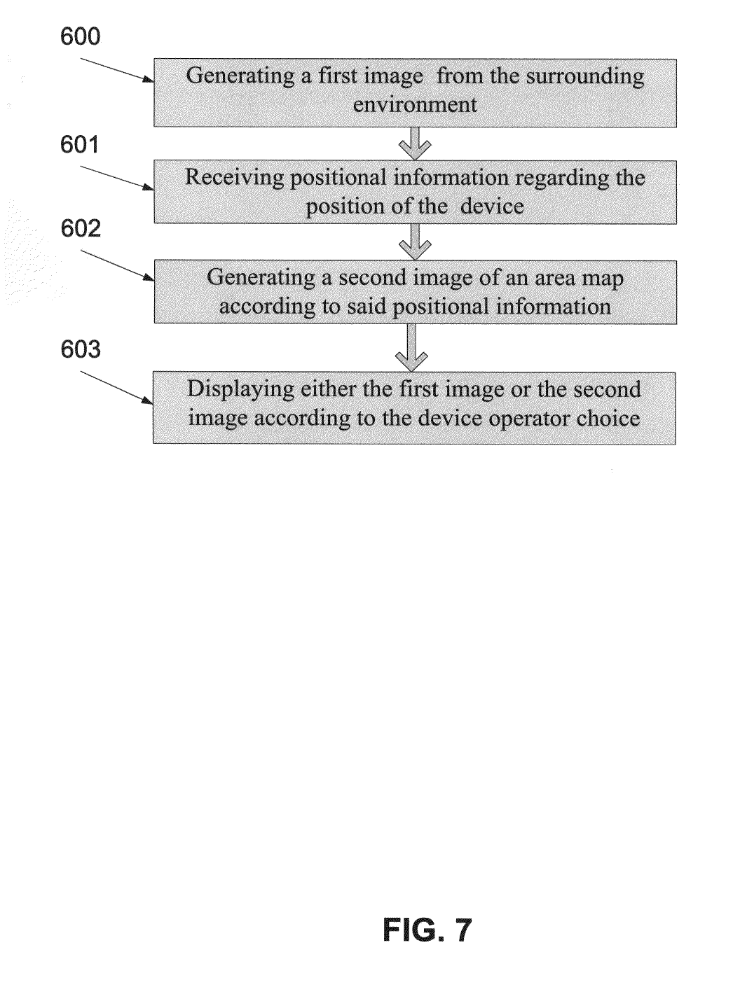

Reference is now made to FIG. 7, which is a flowchart of an exemplary method, according to a preferred embodiment of the present invention, for using a remote viewing device for generating a daylight image and a map area display. During the first step, as shown at 600, an image that represents a portion of the surrounding environment is generated. The image can be generated either by a daylight sensor or by an electrochemical sensor. During the subsequent step, as shown at 601, positional information regarding the position of the device is received from a positioning module of the remote viewing device. The positioning module may be a GPS module, as described above. Based upon the received positional information, a visual image of an area map that depicts the region of the remote viewing device is generated, as depicted at 602. Then, as shown at 603, the device operator chooses to display either the image that represents the light reflected from a portion of the surrounding environment or the visual image of an area map.

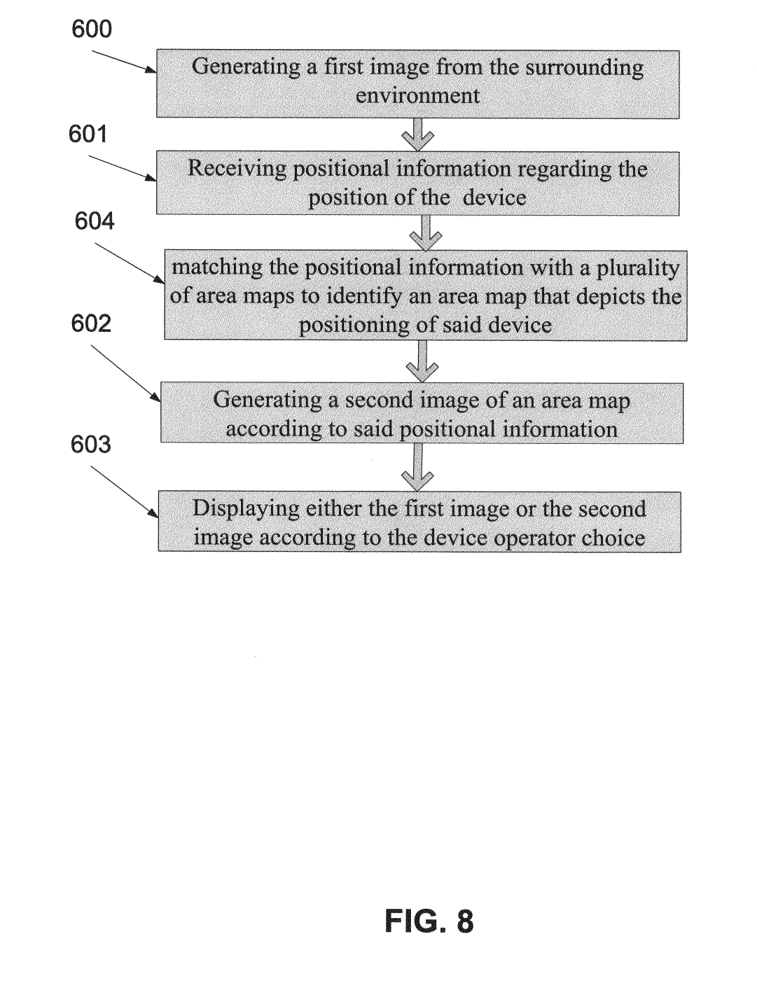

Reference is now made to FIG. 8 which shows another flowchart of an exemplary method according to a preferred embodiment. Steps 600-603 are similar to those shown in FIG. 7 above. However, FIG. 8 includes the further step 604 of comparing the positional information which has been previously received, in step 601, with a number of area maps. The comparing is done in order to identify an area map that depicts the position of the device. As described above, the area maps may be stored on a replaceable storage device, enabling the operator to search a storage device which is likely to match the region in which the device is positioned.

It is expected that during the life of this patent many relevant devices and systems will be developed and the scope of the terms herein, particularly of the terms range finding module, sensor, IR sensor, image sensor, computing unit, inclinometer, and compass are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1-38. (canceled)

39. An apparatus for enhanced remote viewing, comprising:
an image sensor for acquiring a digital image of a remote view;
a location module for acquiring a location;
a map module for generating a visual positional data in accordance with said location; and
an output module for outputting a processed image comprising at least one of said digital image said visual positional data, and a combination thereof, said processed image being outputted to a common display.

40. The apparatus of claim 39, wherein said map module, comprises:
a map repository configured to store a plurality of maps, each map comprising reference information;
and
a computing unit for matching said reference information of said plurality of maps with said location, said computing unit being configured generating said visual positional data based on said matching.

41. The apparatus of claim 40, further comprising a data connection, wherein said map repository is adapted to access said plurality of maps via said data connection.

42. The apparatus of claim 39, wherein said location module comprises a global positioning system (GPS) module, wherein said location comprises at least one of the following information: the latitude of said apparatus, the longitude of said apparatus, time reference data, and the elevation of said apparatus.

43. The apparatus of claim 39, wherein said location module comprises a range finding module configured to output range information regarding a chosen object.

44. The apparatus of claim 43, wherein said range finding module is a laser range finding module, configured to determine at least one of a direction to and a velocity of a viewed object.

45. The apparatus of claim 43, wherein said map module uses said location and said range information to calculate target positional information, wherein said view comprises a representation of said target positional information, or further comprising a communication interface, said communication interface is used to transmit said range information.

46. The apparatus of claim 43, further comprising a pointer module, configured to point to said chosen object.

47. The apparatus of claim 43, wherein said common display is an ocular viewer having a pair of eyepieces.

48. The apparatus of claim 43 wherein said common display is an ocular viewer having a single eyepiece.

49. The apparatus of claim 39, wherein said image sensor comprises a digital zoom module for changing said remote view by enlarging a cropped portion of said remote view.

50. The apparatus of claim 39, wherein said image sensor comprises a set of positionable optical lenses that image said remote view so as to form a field of view of a real image of said remote view.

51. The apparatus of claim 39, wherein said location module comprises an inclinometer module configured to generate angular information regarding said apparatus, and wherein said common display is adapted to display said angular information.

52. The apparatus of claim 39, wherein said location module comprises a compass module adapted to output horizontal angular information regarding said apparatus, and wherein said common display is adapted to display said_horizontal angular information.

53. The apparatus of claim 39, further comprising a transmission unit configured to transmit said viewing signals of said image comprising at least one of said remote view.

54. The apparatus of claim 39, further comprising a communication interface configured to transmit said viewing signals of said image comprising at least one of said remote view, and of said map, wherein said communication interface is configured to receive an external visual image from an associated device, wherein said output module is used for displaying said external visual image.

55. The apparatus of claim 39, wherein said an image comprising said combination and wherein said combination is a split view that simultaneously display a first visual image based on said visual positional data and a second visual image based on said remote view.

56. The apparatus of claim 39, further comprising an image repository, wherein said image repository is used for storing said digital image.

57. The apparatus of claim 39, further comprising a communication interface configured to transmit said viewing signals of said image comprising at least one of said remote view, and of said visual positional data.

58. The apparatus of claim 39, further comprising a cellular transmitter, wherein said cellular transmitter is used to send said digital image using multimedia messaging service (MMS) protocol.

59. The apparatus of claim 39, wherein said visual positional data comprises a representation of a terrain in the surrounding of said apparatus, wherein said visual positional data comprises at least one of the following representations: a three-dimensional (3D) representation, a two-dimensional (2D) representation, and a geodesic representation.

60. A method for using an apparatus for generating a real world image and a visual positional data area display relating thereto, comprising the steps of:
a) generating a first digital image from the surrounding environment;
b) receiving positional information in relation thereto;
c) generating a second digital image comprising a visual positional data defined according to said positional information; and
d) displaying either said first image or said second image or a combination thereof on a common display according to a user selection.

61. The method of claim 57, further comprising a step between b) and c) of selecting an object, and a step measuring the distance between said device to said object; wherein said second image depicts said distance.

62. The method of claim 57, further comprising a step between b) and c) of matching said positional information with a plurality of area maps stored on said device to identify an area map that depicts the positioning of said device.

63. The method of claim 58, wherein said plurality of area maps is stored on a replaceable memory device which is connected to said device.
